(19) United States
(12) Patent Application Publication
(10) Pub. No.: US 2022/0210841 A1
(43) Pub. Date: Jun. 30, 2022

(54) METHOD AND APPARATUS FOR RANDOM ACCESS

(71) Applicant: Telefonaktiebolaget LM Ericsson (publ), Stockholm (SE)

(72) Inventors: Zhipeng LIN, Nanjing (CN); Jingya LI, Göteborg (SE); Robert Mark HARRISON, Grapevine, TX (US)

(73) Assignee: Telefonaktiebolaget LM Ericsson (publ), Stockholm (SE)

(21) Appl. No.: 17/594,603

(22) PCT Filed: Apr. 23, 2020
(86) PCT No.: PCT/CN2020/086441

§ 371 Date: Oct. 22, 2021

(30) Foreign Application Priority Data
Apr. 30, 2019 (CN) PCT/CN2019/085303

(51) Int. Cl. H04W 74/08; H04W 72/04; H04W 72/12; H04W 56/00

(52) U.S. Cl. CPC H04W 74/0841; H04W 74/0866; H04W 56/001; H04W 72/1263; H04W 72/0446

(57) ABSTRACT

A method for random access which may be performed by a terminal device comprises receiving, from a network node, information indicating an association between a downlink transmission and an uplink transmission (e.g. an association between a synchronization signal and physical broadcast channel block and a shared channel occasion) in a random access procedure. The association is based at least in part on configuration of random access resource (e.g. a random access occasion) and shared channel resource (e.g. the shared channel occasion) for an uplink message (e.g. including a preamble and physical uplink shared channel data) in the random access procedure. An association between a synchronization signal and physical broadcast channel block and a shared channel occasion in a random access procedure can be configured flexibly and efficiently.

### FIELD OF THE INVENTION

The present disclosure generally relates to communication networks, and more specifically, to method and apparatus for random access.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the rapid development of networking and communication technologies, wireless communication networks such as long-term evolution (LTE) and new radio (NR) networks are expected to achieve high traffic capacity and end-user data rate with lower latency. In order to connect to a network node, a random access (RA) procedure may be initiated for a terminal device. In the RA procedure, system information (SI) and synchronization signals (SS) as well as the related radio resource and transmission configuration can be informed to the terminal device by control information from the network node. The RA procedure can enable the terminal device to establish a session for a specific service with the network node. Thus, it is desirable to enhance the configuration and performance of the RA procedure.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

A wireless communication network such as a NR/5G network may be able to support flexible network configuration. Various signaling approaches (e.g., a four-step approach, a two-step approach, etc.) may be used for a RA procedure of a terminal device to set up a connection with a network node. For the RA procedure, there may be a specific association between a synchronization signal and physical broadcast channel block (which is also known as a SS/PBCH block or SSB for short) and a time-frequency physical random access channel (PRACH) occasion (which is also known as a RA occasion or RO for short). In a two-step RA procedure, the terminal device can transmit a RA preamble together with the physical uplink shared channel (PUSCH) in a message (which is also known as message A or msgA for short) to the network node, and receive a response message (which is also known as message B or msgB for short) from the network node. The msgA payload can be transmitted in a PUSCH occasion (PO) configured with one or more resource units (RUs), and the RA preamble can be transmitted in a RO. It may be desirable to configure signaling transmissions for a RA procedure more flexibly and efficiently while implementing association of resource configuration in a RO and a PO.

Various embodiments of the present disclosure propose a solution for RA, which can support adaptive configuration for a RA procedure such as a two-step RA procedure, for example, by providing flexibility for mapping of an SSB to a PO, so as to save overhead and improve performance of the RA procedure.

It can be realized that the terms “PRACH occasion”, “random access channel (RACH) occasion” or “RA occasion” mentioned herein may refer to a time-frequency resource usable for the preamble transmission in a RA procedure, which may also be referred to as “random access occasion (RO)”. These terms may be used interchangeably in this document. In accordance with some exemplary embodiments, a RO usable for the preamble transmission in two-step RA may be called a two-step RO, while a RO usable for the preamble transmission in four-step RA may be called a four-step RO.

Similarly, it can be realized that the terms “PUSCH occasion”, “uplink shared channel occasion” or “shared channel occasion” mentioned herein may refer to a time-frequency resource usable for PUSCH transmission in a RA procedure, which may also be referred to as “physical uplink shared channel occasion (PO)”. These terms may be used interchangeably in this document.

According to a first aspect of the present disclosure, there is provided a method performed by a network node. The method comprises determining an association between an SSB and a shared channel occasion (e.g., PUSCH occasion) in a RA procedure, based at least in part on configuration of a RA occasion and the shared channel occasion for an uplink (UL) message including a preamble and PUSCH data in the RA procedure. The method further comprises transmitting information indicating the association to a terminal device.

According to a second aspect of the present disclosure, there is provided an apparatus which may be implemented as a network node. The apparatus comprises one or more processors and one or more memories comprising computer program codes. The one or more memories and the computer program codes are configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a network node. The apparatus comprises a determining unit and a transmitting unit. In accordance with some exemplary embodiments, the determining unit is operable to carry out at least the determining step of the method according to the first aspect of the present disclosure. The transmitting unit is operable to carry out at least the transmitting step of the method according to the first aspect of the present disclosure.

According to a fifth aspect of the present disclosure, there is provided a method performed by a terminal device such as a user equipment (UE). The method comprises receiving, from a network node, information indicating an association between an SSB and a shared channel occasion (e.g., PUSCH occasion) in a RA procedure. The association may be based at least in part on configuration of a RA occasion and the shared channel occasion for an UL message including a preamble and PUSCH data in the RA procedure. Optionally, the method may further comprise performing the RA procedure, according to the information received from the network node.

According to a sixth aspect of the present disclosure, there is provided an apparatus which may be implemented as a terminal device. The apparatus comprises one or more processors and one or more memories comprising computer program codes. The one or more memories and the computer program codes are configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus which may be implemented as a terminal device. The apparatus comprises a receiving unit, and optionally a performing unit. In accordance with some exemplary embodiments, the receiving unit is operable to carry out at least the receiving step of the method according to the fifth aspect of the present disclosure. The performing unit is operable to carry out at least the performing step of the method according to the fifth aspect of the present disclosure.

In accordance with an exemplary embodiment, the RA procedure may be the two-step RA procedure.

In accordance with an exemplary embodiment, the UL message may comprise message A including a preamble and PUSCH data (e.g., the RA preamble together with msgA payload).

In accordance with an exemplary embodiment, UL transmission in the shared channel occasion may be associated with one or more preambles mapped to one or more SSBs.

In accordance with an exemplary embodiment, the shared channel occasion may be configured with a shared channel on which one or more reception beams of the network node associated with one or more SSBs may be usable to receive data transmitted by the terminal device.

In accordance with an exemplary embodiment, the configuration of the RA occasion and the shared channel occasion may comprise one of:
one-to-one mapping of a preamble in the RA occasion to a RU in the shared channel occasion; and
multiple-to-one mapping of preambles in the RA occasion to a RU in the shared channel occasion.

In accordance with an exemplary embodiment, the association between the SSB and the shared channel occasion may comprise: mapping of the SSB to a set of shared channel occasions comprising at least the shared channel occasion. The set of shared channel occasions may be configured with the same resource in time domain.

In accordance with an exemplary embodiment, the SSB may be mapped to one or more preambles which are in the RA occasion and associated with one or more RUs in the set of shared channel occasions.

In accordance with an exemplary embodiment, the association between the SSB and the shared channel occasion may comprise: mapping of a set of SSBs comprising the SSB to the shared channel occasion.

In accordance with an exemplary embodiment, the SSB may be mapped to at least a part of preambles which are in the RA occasion and associated with at least one RU in the shared channel occasion.

In accordance with an exemplary embodiment, the set of SSBs may be configured to enable optimized decoding of UL transmission of the terminal device.

In accordance with an exemplary embodiment, the set of SSBs may be configured to have a beam difference higher than a predefined threshold.

According to a ninth aspect of the present disclosure, there is provided a method performed by a network node. The method comprises determining configuration information for a RA procedure (e.g., a two-step RA procedure). The configuration information indicates a number of one or more SSBs associated with a RA occasion, and a number of one or more preambles which are in the RA occasion and associated with shared channel resource for the RA procedure. The method further comprises transmitting the configuration information to a terminal device.

In accordance with an exemplary embodiment, the method according to the ninth aspect of the present disclosure may further comprise: transmitting signaling information to the terminal device. The signaling information may indicate an offset which is usable for determining a start preamble associated with a specific SSB in the RA occasion.

In accordance with an exemplary embodiment, the method according to the ninth aspect of the present disclosure may further comprise: receiving an UL message (e.g., message A) for RA transmitted by the terminal device. The transmission of the UL message may use at least one preamble of the one or more preambles and the associated shared channel resource. The at least one preamble may be identified by at least one indicator which may be determined based at least in part on the configuration information.

According to a tenth aspect of the present disclosure, there is provided an apparatus which may be implemented as a network node. The apparatus comprises one or more processors and one or more memories comprising computer program codes. The one or more memories and the computer program codes are configured to, with the one or more processors, cause the apparatus at least to perform any step of the method according to the ninth aspect of the present disclosure.

According to an eleventh aspect of the present disclosure, there is provided a computer-readable medium having computer program codes embodied thereon which, when executed on a computer, cause the computer to perform any step of the method according to the ninth aspect of the present disclosure.

According to a twelfth aspect of the present disclosure, there is provided an apparatus which may be implemented as a network node. The apparatus comprises a determining unit and a transmitting unit. In accordance with some exemplary embodiments, the determining unit is operable to carry out at least the determining step of the method according to the ninth aspect of the present disclosure. The transmitting unit is operable to carry out at least the transmitting step of the method according to the ninth aspect of the present disclosure.

According to a thirteenth aspect of the present disclosure, there is provided a method performed by a terminal device such as a UE. The method comprises receiving configuration information for a RA procedure from a network node. The configuration information indicates a number of one or more SSBs associated with a RA occasion, and a number of one or more preambles which are in the RA occasion and associated with shared channel resource for the RA procedure. The method further comprises performing the RA procedure, according to the configuration information received from the network node.

In accordance with an exemplary embodiment, the method according to the thirteenth aspect of the present disclosure may further comprise: receiving signaling information from the network node. The signaling information may indicate an offset which is usable for determining a start preamble associated with a specific SSB in the RA occasion.

In accordance with an exemplary embodiment, the terminal device may perform the RA procedure by:
determining at least one indicator for the one or more preambles, based at least in part on the configuration information; and
transmitting an UL message for RA to the network node, by using at least one preamble of the one or more preambles and the associated shared channel resource, wherein the at least one preamble is identified by the at least one indicator.

According to a fourteenth aspect of the present disclosure, there is provided an apparatus which may be implemented as a terminal device. The apparatus comprises one or more processors and one or more memories comprising computer program codes. The one or more memories and the computer program codes are configured to, with the one or more processors, cause the apparatus at least to perform any step of the method according to the thirteenth aspect of the present disclosure.

According to a fifteenth aspect of the present disclosure, there is provided a computer-readable medium having computer program codes embodied thereon which, when executed on a computer, cause the computer to perform any step of the method according to the thirteenth aspect of the present disclosure.

According to a sixteenth aspect of the present disclosure, there is provided an apparatus which may be implemented as a terminal device. The apparatus comprises a receiving unit and a performing unit. In accordance with some exemplary embodiments, the receiving unit is operable to carry out at least the receiving step of the method according to the thirteenth aspect of the present disclosure. The performing unit is operable to carry out at least the performing step of the method according to the thirteenth aspect of the present disclosure.

In accordance with an exemplary embodiment, the shared channel resource may comprise shared channel resource units which are frequency division multiplexed in one or more symbols.

In accordance with an exemplary embodiment, the number of the one or more preambles may be equal to an integer multiple of a number of the shared channel resource units.

In accordance with an exemplary embodiment, the offset may be equal to a number of one or more preambles which are configured for another RA procedure (e.g., a four-step RA procedure) and associated with the specific SSB.

According to a seventeenth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the method according to any of the first aspect and the ninth aspect of the present disclosure.

According to an eighteenth aspect of the present disclosure, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the method according to any of the first aspect and the ninth aspect of the present disclosure.

According to a nineteenth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to any of the fifth aspect and the thirteenth aspect of the present disclosure.

According to a twentieth aspect of the present disclosure, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the method according to any of the fifth aspect and the thirteenth aspect of the present disclosure.

According to a twenty-first aspect of the present disclosure, there is provided a method implemented in a communication system which may include a host computer, a base station and a UE. The method may comprise, at the host computer, receiving user data transmitted to the base station from the UE which may perform any step of the method according to any of the fifth aspect and the thirteenth aspect of the present disclosure.

According to a twenty-second aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to any of the fifth aspect and the thirteenth aspect of the present disclosure.

According to a twenty-third aspect of the present disclosure, there is provided a method implemented in a communication system which may include a host computer, a base station and a UE. The method may comprise, at the host computer, receiving, from the base station, user data originating from a transmission which the base station has received from the UE. The base station may perform any step of the method according to any of the first aspect and the ninth aspect of the present disclosure.

According to a twenty-fourth aspect of the present disclosure, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the method according to any of the first aspect and the ninth aspect of the present disclosure.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1A is a diagram illustrating an exemplary four-step RA procedure according to an embodiment of the present disclosure;

FIG. 1B is a diagram illustrating an exemplary PRACH configuration according to an embodiment of the present disclosure;

FIGS. 1C-1D are diagrams illustrating examples of an association between an SSB and a PRACH occasion according to some embodiments of the present disclosure;

FIG. 1E is a diagram illustrating an example of mapping between an SSB and RA preambles according to an embodiment of the present disclosure;

FIG. 1F is a diagram illustrating exemplary preambles per SSB per PRACH occasion according to an embodiment of the present disclosure;

FIG. 2 is a diagram illustrating an exemplary two-step RA procedure according to an embodiment of the present disclosure;

FIGS. 3A-3F are diagrams illustrating examples of association configuration for two-step RA according to some embodiments of the present disclosure;

FIG. 4A is a flowchart illustrating a method according to some embodiments of the present disclosure;

FIG. 4B is a flowchart illustrating another method according to some embodiments of the present disclosure;

FIG. 5A is a flowchart illustrating another method according to some embodiments of the present disclosure;

FIG. 5B is a flowchart illustrating yet another method according to some embodiments of the present disclosure;

FIG. 6 is a block diagram illustrating an apparatus according to some embodiments of the present disclosure;

FIG. 7 is a block diagram illustrating another apparatus according to some embodiments of the present disclosure;

FIG. 8 is a block diagram illustrating yet another apparatus according to some embodiments of the present disclosure;

FIG. 9 is a block diagram illustrating a telecommunication network connected via an intermediate network to a host computer in accordance with some embodiments of the present disclosure;

FIG. 10 is a block diagram illustrating a host computer communicating via a base station with a UE over a partially wireless connection in accordance with some embodiments of the present disclosure;

FIG. 11 is a flowchart illustrating a method implemented in a communication system, in accordance with an embodiment of the present disclosure;

FIG. 12 is a flowchart illustrating a method implemented in a communication system, in accordance with an embodiment of the present disclosure;

FIG. 13 is a flowchart illustrating a method implemented in a communication system, in accordance with an embodiment of the present disclosure; and

FIG. 14 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Wireless communication networks are widely deployed to provide various telecommunication services such as voice, video, data, messaging and broadcasts. As described previously, in order to connect to a network node such as a gNB in a wireless communication network, a terminal device such as a UE may need to perform a RA procedure to exchange essential information and messages for communication link establishment with the network node.

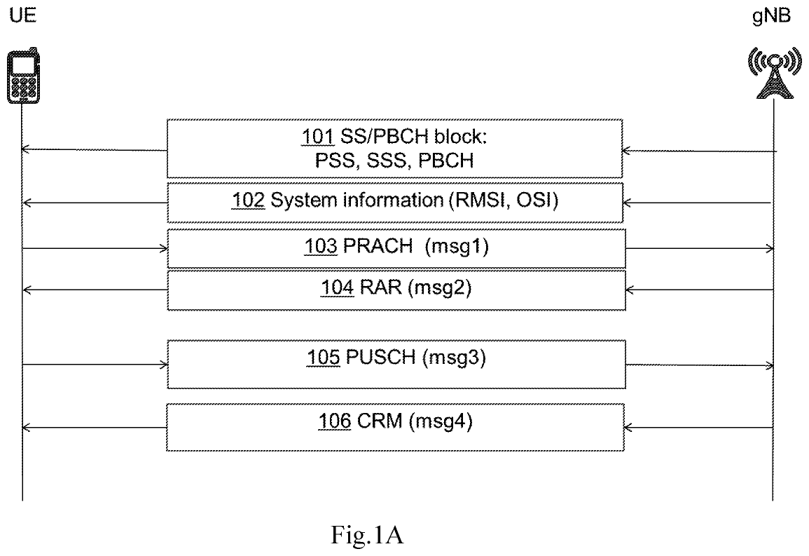

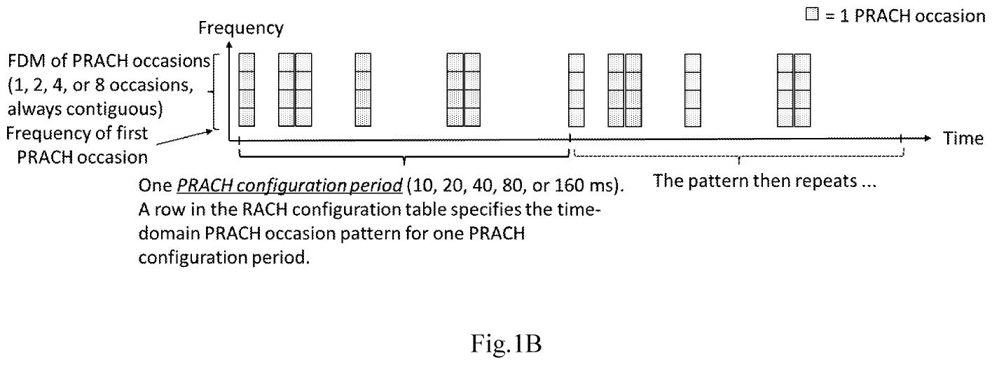

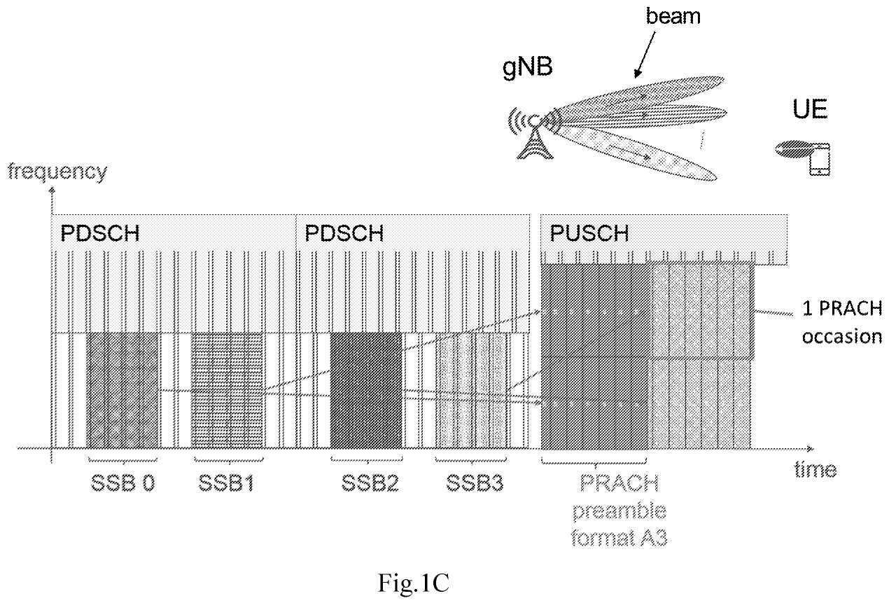

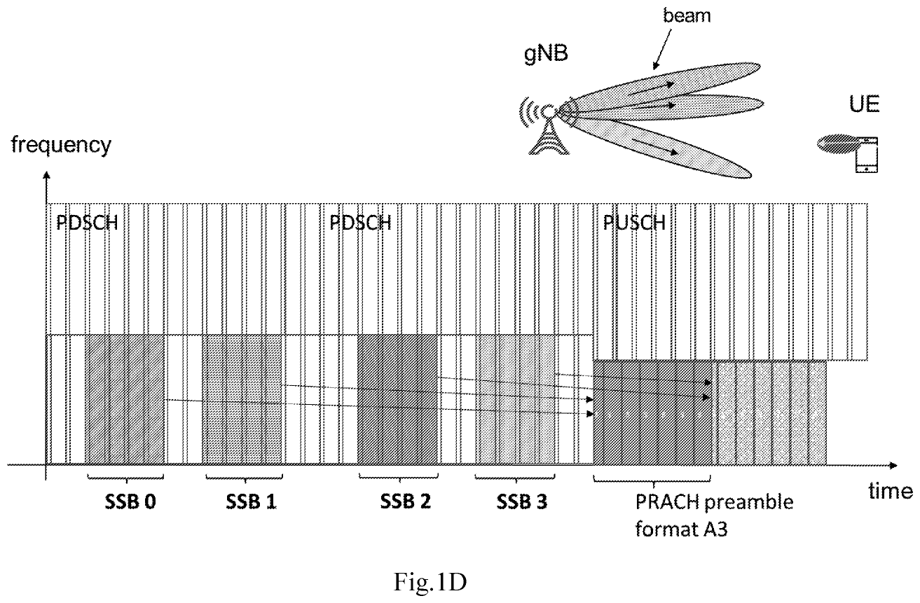

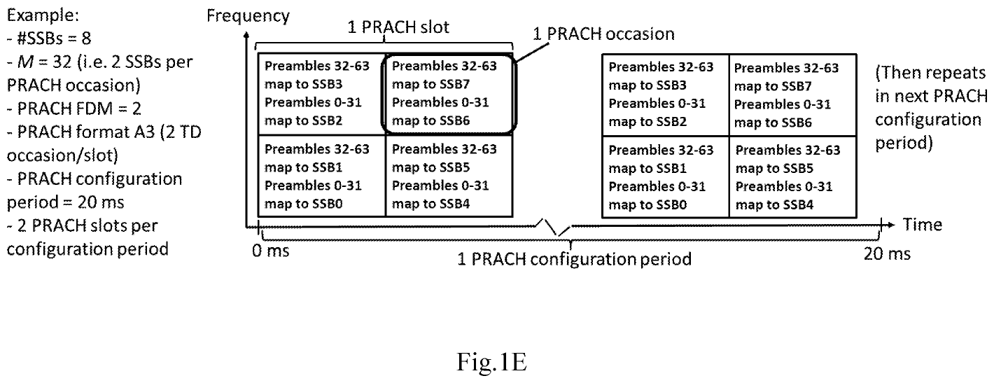

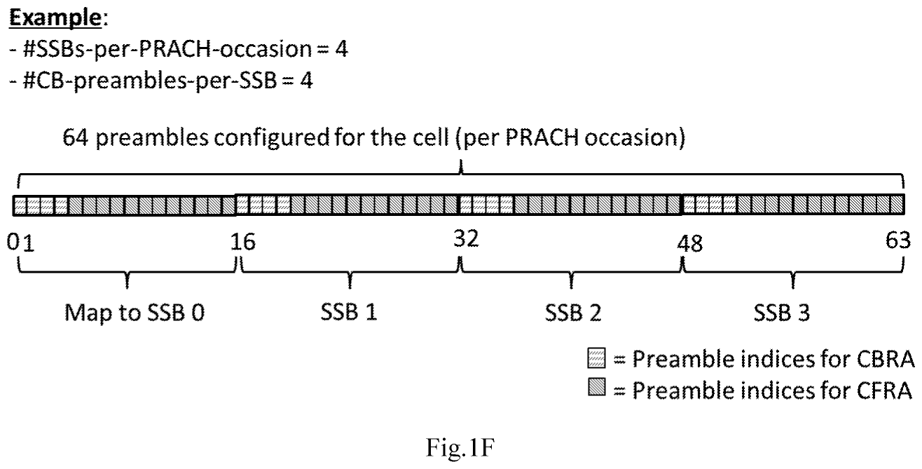

FIG. 1A is a diagram illustrating an exemplary four-step RA procedure according to an embodiment of the present disclosure. As shown in FIG. 1A, a UE can detect a synchronization signal (SS) by receiving 101 an SSB (e.g., a primary synchronization signal (PSS), a secondary synchronization signal (SSS), and physical broadcast channel (PBCH)) from a gNB. The UE can decode 102 some system information (e.g., remaining minimum system information (RMSI) and other system information (OSI)) broadcasted in the downlink (DL). Then the UE can transmit 103 a PRACH preamble (message1/msg1) in the uplink (UL). The gNB can reply 104 with a random access response (RAR, message2/msg2). In response to the RAR, the UE can transmit 105 the UE's identification information (message3/msg3) on physical uplink shared channel (PUSCH). Then the gNB can send 106 a contention resolution message (CRM, message4/msg4) to the UE.

In this exemplary procedure, the UE transmits message3/msg3 on PUSCH after receiving a timing advance command in the RAR, allowing message3/msg3 on PUSCH to be received with timing accuracy within a cyclic prefix (CP). Without this timing advance, a very large CP may be needed in order to be able to demodulate and detect message3/msg3 on PUSCH, unless the communication system is applied in a cell with very small distance between the UE and the gNB. Since a NR system can also support larger cells with a need for providing a timing advance command to the UE, the four-step approach is needed for the RA procedure.

In the NR system, the time and frequency resource on which a PRACH preamble is transmitted can be defined as a PRACH occasion. Different PRACH configurations may be specified for FR1 (Frequency Range 1) paired spectrum, FR1 unpaired spectrum and FR2 (Frequency Range 2) with unpaired spectrum, respectively. The specified PRACH configuration can be maintained in a PRACH configuration table. The time resource and preamble format for PRACH transmission can be configured by a PRACH configuration index, which indicates a row in a PRACH configuration table. For example, at least part of PRACH configurations for preamble format 0 for FR1 unpaired spectrum is shown in Table 1.

TABLE 1

| | | | | | | | Nₜ^{RA, slot}, | |
|---|---|---|---|---|---|---|---|---|
| | | | | | | | number of | |
| | | | | | | Number of | time-domain | |
| | | | | | | PRACH | PRACH | |
| PRACH | | | | | | slots | occasions | N_{dur}^{RA}, |
| Configuration | Preamble | n_{SFN} mod x = y | | Subframe | Starting | within a | within a | PRACH |
| Index | format | x | y | number | symbol | subframe | PRACH slot | duration |
| 0 | 0 | 16 | 1 | 9 | 0 | — | — | 0 |
| 1 | 0 | 8 | 1 | 9 | 0 | — | — | 0 |
| 2 | 0 | 4 | 1 | 9 | 0 | — | — | 0 |
| 3 | 0 | 2 | 0 | 9 | 0 | — | — | 0 |
| 4 | 0 | 2 | 1 | 9 | 0 | — | — | 0 |
| 5 | 0 | 2 | 0 | 4 | 0 | — | — | 0 |
| 6 | 0 | 2 | 1 | 4 | 0 | — | — | 0 |
| 7 | 0 | 1 | 0 | 9 | 0 | — | — | 0 |
| 8 | 0 | 1 | 0 | 8 | 0 | — | — | 0 |
| 9 | 0 | 1 | 0 | 7 | 0 | — | — | 0 |
| 10 | 0 | 1 | 0 | 6 | 0 | — | — | 0 |
| 11 | 0 | 1 | 0 | 5 | 0 | — | — | 0 |
| 12 | 0 | 1 | 0 | 4 | 0 | — | — | 0 |
| 13 | 0 | 1 | 0 | 3 | 0 | — | — | 0 |
| 14 | 0 | 1 | 0 | 2 | 0 | — | — | 0 |
| 15 | 0 | 1 | 0 | 1, 6 | 0 | | | 0 |
| 16 | 0 | 1 | 0 | 1, 6 | 7 | — | — | 0 |
| 17 | 0 | 1 | 0 | 4, 9 | 0 | — | — | 0 |
| 18 | 0 | 1 | 0 | 3, 8 | 0 | — | — | 0 |
| 19 | 0 | 1 | 0 | 2, 7 | 0 | — | — | 0 |
| 20 | 0 | 1 | 0 | 8, 9 | 0 | — | — | 0 |
| 21 | 0 | 1 | 0 | 4, 8, 9 | 0 | — | — | 0 |
| 22 | 0 | 1 | 0 | 3, 4, 9 | 0 | — | — | 0 |
| 23 | 0 | 1 | 0 | 7, 8, 9 | 0 | — | — | 0 |
| 24 | 0 | 1 | 0 | 3, 4, 8, 9 | 0 | — | — | 0 |
| 25 | 0 | 1 | 0 | 6, 7, 8, 9 | 0 | — | — | 0 |
| 26 | 0 | 1 | 0 | 1, 4, 6, 9 | 0 | — | — | 0 |
| 27 | 0 | 1 | 0 | 1, 3, 5, 7, 9 | 0 | — | — | 0 |

In Table 1, the value of x indicates the PRACH configuration period in number of system frames, and the value of y indicates the system frame within each PRACH configuration period on which the PRACH occasions are configured. For instance, if y is set to 0, then it means that PRACH occasions are only configured in the first frame of each PRACH configuration period. The value in the column “Subframe number” tells on which subframes PRACH occasions are configured. The value in the column “Starting symbol” is the symbol index.

In the case of time division duplexing (TDD), semi-statically configured DL parts and/or actually transmitted SSBs can override and invalidate some time-domain PRACH occasions defined in the PRACH configuration table. More specifically, PRACH occasions in the UL part are always valid, and a PRACH occasion within a certain part (e.g., a part with flexible symbols within a NR slot) is valid as long as it does not precede or collide with an SSB in the RACH slot and there are at least N symbols after the DL part and the last symbol of an SSB. For example, N may be set as 0 or 2, depending on the PRACH format and subcarrier spacing.

FIG. 1B is a diagram illustrating an exemplary PRACH configuration according to an embodiment of the present disclosure. In the frequency domain, a NR system can support multiple frequency-multiplexed PRACH occasions on the same time-domain PRACH occasion. This is mainly motivated by the support of analog beam sweeping in the NR system such that the PRACH occasions associated to one SSB are configured at the same time instance but different frequency locations. As shown in FIG. 1B, the number of PRACH occasions frequency-division multiplexed (FDMed) in one time domain PRACH occasion may be 1, 2, 4, or 8, and the PRACH configuration period may be 10 ms, 20 ms, 40 ms, 80 ms or 160 ms. As mentioned previously, a row in a PRACH/RACH configuration table can specify the time-domain PRACH occasion pattern for one PRACH configuration period.

In accordance with an exemplary embodiment, there are up to 64 sequences that can be used as RA preambles per PRACH occasion in each cell. The radio resource control (RRC) parameter such as totalNumberOfRA-Preambles can be used to determine how many of these 64 sequences are used as RA preambles per PRACH occasion in each cell. The 64 sequences may be configured by including firstly all the available cyclic shifts of a root Zadoff-Chu sequence, and secondly in the order of increasing root index, until 64 preambles have been generated for the PRACH occasion.

According to some exemplary embodiments, there may be an association between an SSB and a PRACH occasion. For example, one-to-one association between an SSB and a PRACH occasion (e.g., one SSB per PRACH occasion) can be supported in the NR system. Similarly, one-to-many and/or many-to-one association between SSB(s) and PRACH occasion(s) can also be supported in the NR system.

FIGS. 1C-1D are diagrams illustrating examples of an association between an SSB and a PRACH occasion according to some embodiments of the present disclosure. In the example of one SSB per PRACH occasion as shown in FIG. 1C, SSB0, SSB1, SSB2 and SSB3 are associated with four different PRACH occasions, respectively. In the example of two SSBs per PRACH occasion as shown in FIG. 1D, SSB0 and SSB1 are associated with a PRACH occasion, and SSB2 and SSB3 are associated with another PRACH occasion. It can be appreciated that the association between an SSB and a PRACH occasion as shown in FIG. 1C or FIG. 1D is just as an example, and other suitable association between an SSB and a PRACH occasion with a proper PRACH preamble format may also be implemented.

In accordance with an exemplary embodiment, a gNB uses different SSB beams to transmit the respective SSBs to a UE. In response to reception of the SSBs from the gNB, the UE detects the best SSB beam, and select a PRACH preamble from one or more PRACH preambles mapped to the corresponding SSB. Then the UE can send the selected PRACH preamble to the gNB in an associated PRACH occasion. When the gNB detects the PRACH preamble transmitted from the UE, according to the association between the PRACH preamble and the corresponding SSB mapped to the SSB beam, the best SSB beam for this UE is known indirectly by the gNB, so that the best SSB beam can be used for transmitting/receiving signals to/from this UE.

In accordance with some exemplary embodiments, the preambles associated to each SSB can be configured by two RRC parameters ssb-perRACH-OccasionAndCB-PreamblesPerSSB and totalNumberOfRA-Preambles, which may be indicated by an information element (IE) such as RACH-ConfigCommon in a system information block (e.g., SIB1). A specific rule may be defined for mapping an SSB to RA preambles. For example, a UE may be provided with a number N of SSBs associated to one PRACH occasion and a number R of contention based (CB) preambles per SSB per valid PRACH occasion by parameter ssb-perRACH-OccasionAndCB-PreamblesPerSSB. If N<1, one SSB is mapped to 1/N consecutive valid PRACH occasions and R contention based preambles with consecutive indexes associated with the SSB per valid PRACH occasion start from preamble index 0. If N≥1, R contention based preambles with consecutive indexes associated with SSB n, 0≤n≤N−1, per valid PRACH occasion start from preamble index n·N_{preamble}^{total}/N, where N_{preamble}^{total} is provided by parameter totalNumberOfRA-Preambles and is an integer multiple of N.

FIG. 1E is a diagram illustrating an example of mapping between an SSB and RA preambles according to an embodiment of the present disclosure. In this example, the number of PRACH slots in one PRACH configuration period is 2, the number of PRACH occasions in one PRACH slot is 4, and the number of SSBs in one PRACH occasion is 2. As shown in FIG. 1E, the mapping between an SSB and PRACH preambles may be done by consecutively associating M preambles to each SSB, where M=N_{preamble}^{total}/N. For instance, the preambles can be taken as follows:

first, in increasing order of preamble indexes within a single PRACH occasion;

second, in increasing order of frequency resource indexes for frequency multiplexed PRACH occasions; and

third, in increasing order of time.

FIG. 1F is a diagram illustrating exemplary preambles per SSB per PRACH occasion according to an embodiment of the present disclosure. In this embodiment, for each SSB, the associated preambles per PRACH occasion are further divided into two sets for contention based random access (CBRA) and contention free random access (CFRA). The number of contention based (CB) preambles per SSB per PRACH occasion may be signaled by a RRC parameter such as CB-preambles-per-SSB. Preamble indices for CBRA and CFRA are mapped consecutively for one SSB in one PRACH occasion, as shown in FIG. 1F.

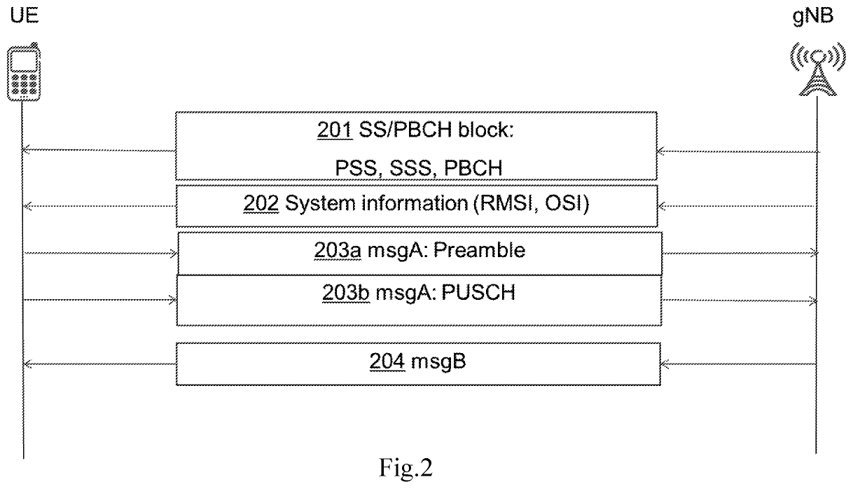

FIG. 2 is a diagram illustrating an exemplary two-step RA procedure according to an embodiment of the present disclosure. Similar to the procedure as shown in FIG. 1A, in the procedure shown in FIG. 2, a UE can detect a SS by receiving 201 an SSB (e.g., comprising a PSS, a SSS and PBCH) from a gNB, and decode 202 system information (e.g., remaining minimum system information (RMSI) and other system information (OSI)) broadcasted in the DL. Compared to the four-step approach as shown in FIG. 1A, the UE performing the procedure in FIG. 2 can complete random access in only two steps. Firstly, the UE sends 203a/203b to the gNB a message A (msgA) including RA preamble together with higher layer data such as a RRC connection request possibly with some payload on PUSCH. Secondly, the gNB sends 204 to the UE a RAR (also called message B or msgB) including UE identifier assignment, timing advance information, a contention resolution message, and etc.

In order to distinguish the legacy UEs performing the four-step RA procedure from the UEs performing the two-step RA procedure, separate PRACH resources (defined by ROs and preamble sequences) can be configured for the two-step RA procedure and the four-step RA procedure. In the two-step RA procedure, the preamble and msgA PUSCH (also called msgA payload) can be transmitted by the UE in one message called message A. The number of preambles (e.g., one or multiple preambles) mapped to one PUSCH resource unit (RU) may be configurable. The PUSCH RU for two-step RA can be defined as the PUSCH occasion (PO) and at least one of demodulation reference signal (DMRS) port and DMRS sequence usable for the msgA payload transmission.

Some agreement may be made regarding the mapping between a preamble in a RO and a PUSCH RU for two-step RA. For example, the network may have the flexibility to support at least one of the following options:
Option I: one-to-one mapping between a preamble in a RO and a RU in an associated PO;
Option II: one-to-multiple mapping between a preamble in a RO and RUs in an associated PO; and
Option III: multiple-to-one mapping between preambles in a RO and a RU in an associated PO.

For four-step RA, the preambles within a single RO may be associated to different SSBs (as shown in FIG. 1E), with each SSB pointing to a different beam direction. For two-step RA, the SSB to preamble and RO mapping may be different for different mapping schemes applied between a RA preamble in a RO and the associated PUSCH RU. Without a careful design of the RA preamble to PUSCH RU mapping, multiple PUSCH transmissions in different transmission (TX) beam directions may be multiplexed in the same PO, or these PUSCH transmissions may be mapped to different POs that are FDMed at the same time instance. Both cases may result in a multi-beam reception issue for PUSCH decoding at the network node, especially when analog beamforming is utilized. In the case of digital beamforming, multiple reception (RX) beams can be used to receive signals at the same time, but when multiple transmissions using the beams with a small beam difference are located on the same occasion, there may be a high collision issue. Therefore, for the two-step RA procedure, it may be desirable to map an SSB to RA preambles associated with PUSCH RU adaptively, according to the configuration (e.g., Option I, Option II or Option III) of the association between a preamble in a RO and a PUSCH

RU.

In the proposed solution according to some exemplary embodiments, a network node can indicate an association between signaling transmissions for a two-step RA procedure to a terminal device. In accordance with an exemplary embodiment, the proposed solution may allow a gNB to inform a UE of the SSB to PO associated RO mapping for a two-step RA procedure. In accordance with some exemplary embodiments, the association between signaling transmissions for the two-step RA procedure may be adaptive to configuration of RA resource and shared channel resource for an uplink message (such as message A containing the preamble and PUSCH payload) for RA. For example, according to the mapping of a preamble in a RO and a RU in a PO, a PO associated SSB can be mapped adaptively to one or more preambles in the associated RO. The proposed solution can minimize reserved resource overhead and improve the decoding performance of the PUSCH transmissions on the same PO (especially for analogue beamforming), while providing the flexibility for the SSB to RO and preamble mapping and the preamble to PUSCH RU mapping.

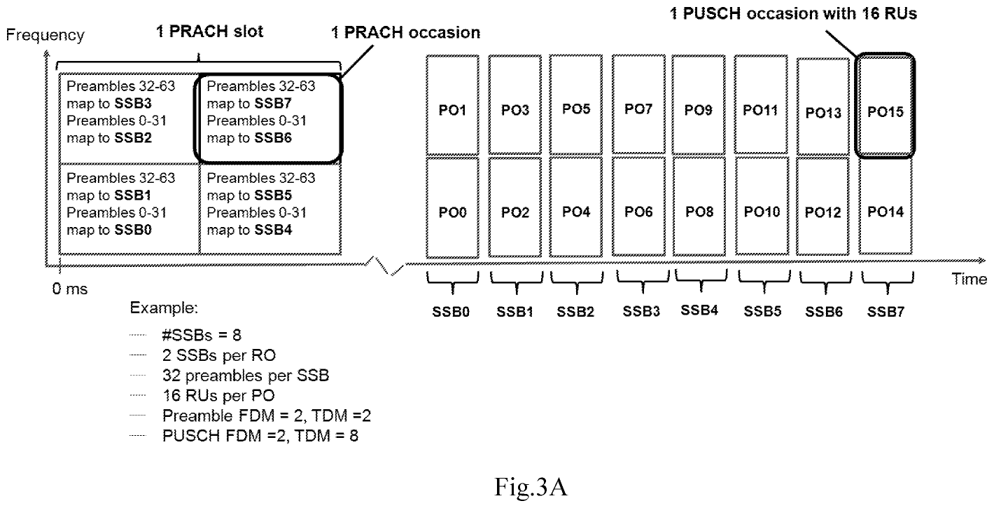

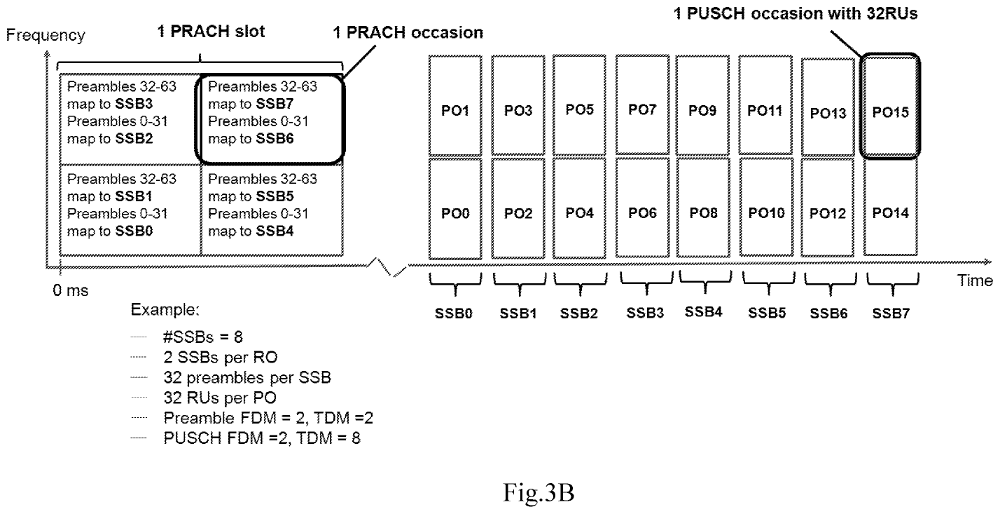

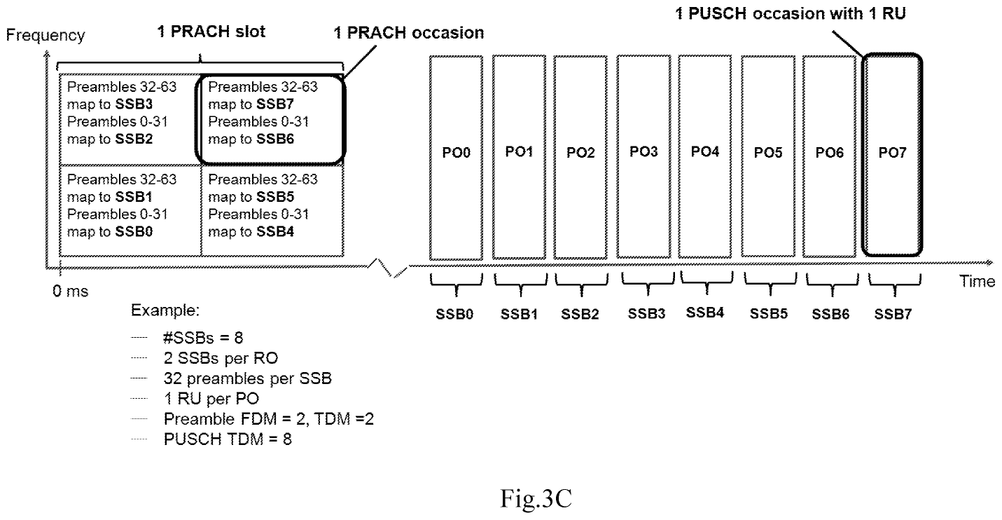

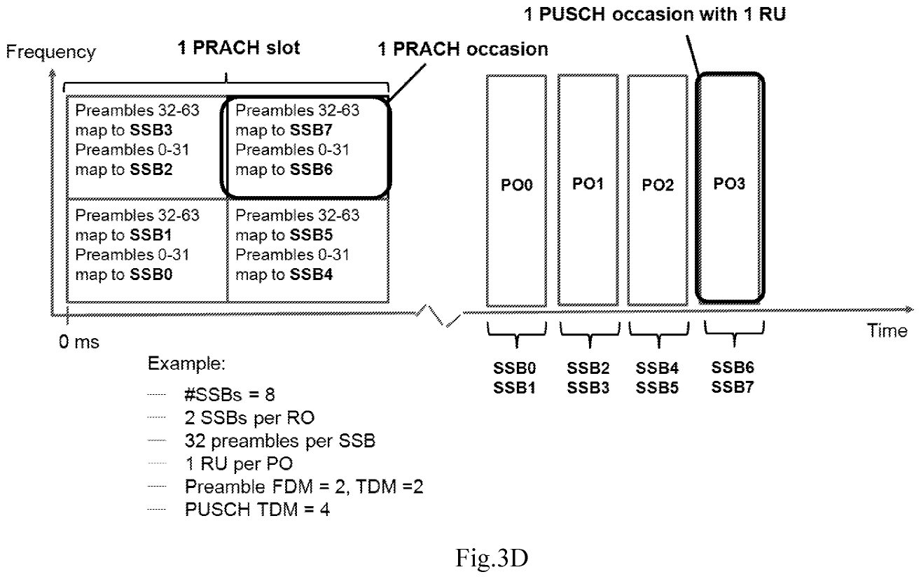

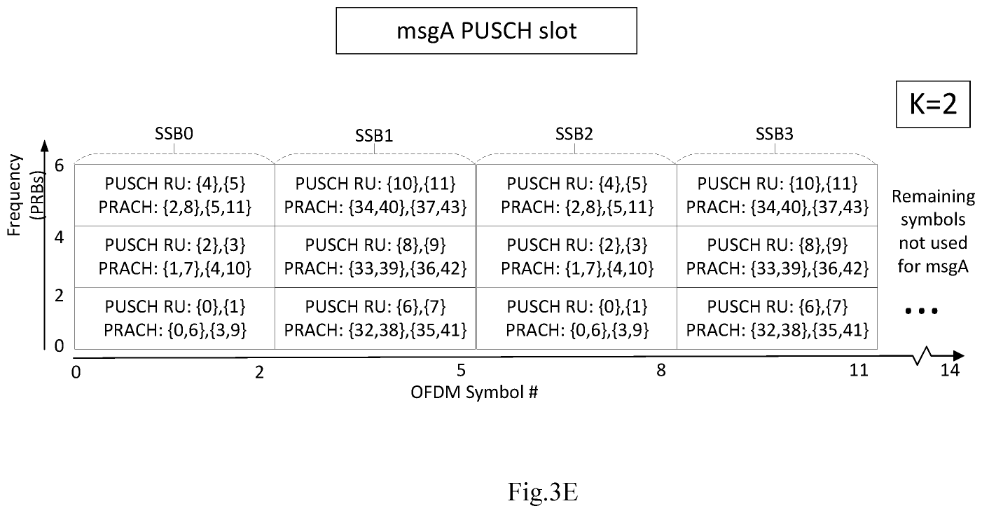

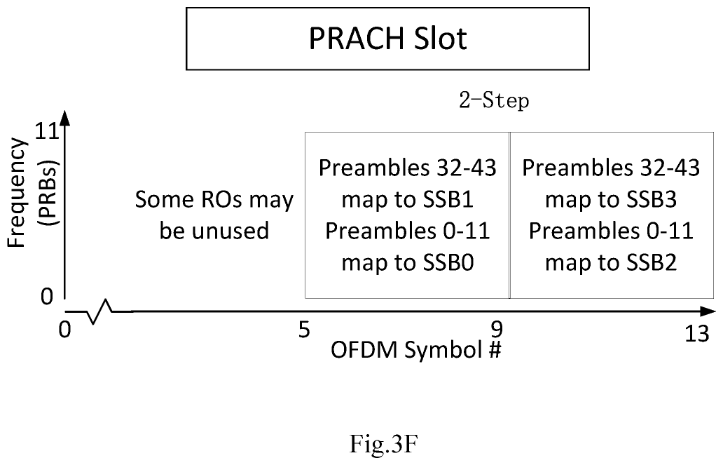

FIGS. 3A-3F are diagrams illustrating examples of association configuration for two-step RA according to some embodiments of the present disclosure. The exemplary association configuration shown in FIG. 3A is for the case of Option I where one-to-one mapping is applied between a preamble in a RO and a RU in a PO. In accordance with an exemplary embodiment, the SSB to RO and preamble mapping rule may be defined, for example, to map the preambles in one RO associated with all the PUSCH RUs in one time domain PO to one SSB, so that multiple UEs with the same or similar beam direction can be grouped into one time domain PO indirectly, because the UEs which detect the SSB beam in this direction as the best beam may select the associated preambles for msgA preamble transmission. This exemplary SSB to RO and preamble mapping rule makes it possible for a gNB to receive a group of UEs in their common best direction in one time domain PO, especially when analogue beamforming is used. Here the time domain PO may comprise one or more POs (e.g., frequency domain POs) which can be FDMed at one time instance.

FIG. 3A provides an example where 16 POs with 16 RUs for each PO are defined, 8 SSBs are transmitted in one cell and 4 ROs are time-frequency multiplexed in one PRACH slot. As shown in FIG. 3A, 16 preambles mapped to one SSBi (i=0, 1, 2, . . . , 7) in one RO can be mapped to one POm (m=0, 2, 4, . . . , 14), and the other 16 preambles for this SSBi in this RO are mapped to other POn (n=1, 3, 5, . . . , 15) multiplexed with POm in frequency domain. POm and POn can be regarded as a time domain PO as a whole. According to the SSB beam associated preamble to PO mapping as shown in FIG. 3A, a single SSB beam is mapped to 2 POs with 16 RUs per PO, and 16 preambles are mapped to one PO with one preamble mapped to one RU.

The exemplary association configuration shown in FIG. 3B is for the case of Option II where one-to-multiple mapping is applied between a preamble in a RO and RUs in a PO. In accordance with an exemplary embodiment, the SSB to RO and preamble mapping rule may be defined, for example, to map the preambles in one RO associated with all the PUSCH RUs in one time domain PO to one SSB, so that multiple UEs with the same or similar beam direction can be grouped into one time domain PO indirectly, because the UEs which detect the SSB beam in this direction as the best beam may select the associated preambles for msgA preamble transmission. This exemplary SSB to RO and preamble mapping rule is similar to the rule used for the case of Option I.

FIG. 3B provides an example similar to FIG. 3A except that 32 RUs are configured in one PO and one preamble is mapped to 2 RUs. According to the SSB beam associated preamble to PO mapping as shown in FIG. 3B, a single SSB beam is mapped to 2 POs with 32 RUs per PO, and 16 preambles are mapped to one PO with one preamble mapped to 2 RUs.

It can be appreciated that the configuration for one-to-multiple mapping of a SSB to POs as shown in FIG. 3A or FIG. 3B is just as an example, and other suitable association between an SSB and a PO (e.g., one-to-one mapping or multiple-to-one mapping) can also be implemented with the proper mapping of a preamble to a RU.

The exemplary association configuration shown in FIG. 3C is for the case of Option III where multiple-to-one mapping is applied between preambles in a RO and a RU in a PO. In this case, the multiple preambles mapped to one RU in one PO may be associated to one or more SSBs depending on whether multiple RX beams are allowed in one PO. In accordance with an exemplary embodiment where one beam for one PO is supported, the SSB to PO mapping is one-to-one mapping to make sure that the single beam requirement is met. In this case, the SSB to RO and preamble mapping rule may be defined, for example, to map multiple preambles associated with the same PUSCH RU (e.g., the RU(s) in the same PO, or in different POs FDMed at the same time instance) to the same SSB, especially for the case that the analogue beamforming is applied.

FIG. 3C provides an example similar to FIG. 3A except that 32 preambles are mapped to one RU and only one PO is configured in one time instance in this case. According to the SSB beam associated preamble to PO mapping as shown in FIG. 3C, a single SSB beam is mapped to one PO with one RU per PO.

In accordance with an exemplary embodiment where multiple beams for one PO are supported, the SSB to PO mapping can be multiple-to-one mapping to reduce the reserved PUSCH resource overhead. In this case, the SSB to RO and preamble mapping rule may be defined, for example, to map multiple preambles associated with the same PUSCH RU (e.g., the RU(s) in the same PO, or in different POs FDMed at the same time instance) to different SSBs.

FIG. 3D provides an example similar to FIG. 3C except that 2 SSBs (and 2 SSB beams) are associated with one RU in one PO and only 4 POs are configured with one PO per time instance in this case. According to the SSB beam associated preamble to PO mapping as shown in FIG. 3D, the multiple SSB beams are mapped to one PO with one RU per PO.

In accordance with some exemplary embodiments, a network node such as gNB can optimize which SSB beams to be associated with one PO, enabling best decoding performance of PUSCHs transmitted with different beams but on the same PO. The optimized association can be done by selecting an SSB beam sweeping order (SSB beam direction to SSB index mapping) at the network node, such that by following the SSB to RO and preamble mapping rule, as well as the preamble to PO and RU mapping rule, the SSB beams that are associated with the same PO can enable good PUSCH decoding performance. According to an exemplary embodiment, preambles associated with SSB beams which are not so close to each other can be grouped into one PO. For example, in FIG. 3D, if SSB0 and SSB1 have a beam difference larger than a predefined threshold, then SSB0 and SSB1 can be grouped to be mapped to one PO such as POO via mapping SSB0 and SSB1 to the left bottom RO in the PRACH slot shown in FIG. 3D.

It can be appreciated that the association configuration for one-to-one mapping of a SSB to a PO as shown in FIG. 3C and multiple-to-one mapping of SSBs to a PO as shown in FIG. 3D are just as examples, and other suitable association between an SSB and a PO (e.g., one-to-multiple mapping) can also be implemented with the proper mapping of a preamble to a RU.

In accordance with some exemplary embodiments, flexible mapping configuration can support a variable number of SSBs and variable PUSCH RU size. The spectral efficiency of msgA PUSCH is expected to be generally substantially less than dynamically scheduled PUSCH (e.g., in four-step RA), since the network normally may not apply link adaptation to msgA PUSCH transmission. Therefore, msgA resource and payload size are conservative, assuming relatively poor channel conditions even when UEs are in good channel conditions. This means that it is desirable to control the number of PUSCH resource units such that they are not over used. A possible way to do this is to have fine granularity in the number of physical resource blocks (PRBs) allocated to POs. For example, the number of POs needs to be set as any non-zero integer up to some limit, such as the number of POs that can fit in an active bandwidth part.

FIG. 3E provides an exemplary PO configuration in which there are 12 POs, each occupying K=2 PRBs in frequency and 3 orthogonal frequency division multiplexing (OFDM) symbols. As shown in FIG. 3E, each PO contains two PUSCH RUs, and each of the PUSCH RUs is associated with a distinct DMRS transmission. The distinct DMRS transmission can be a DMRS antenna port, a DMRS with a different sequence initialization (or equivalently a different DMRS scrambling ID), or a combination of a DMRS antenna port and a DMRS sequence initialization. For example, PUSCH RUs 0, 2, 4, 6, 8, and 10 may correspond to a first DMRS port while PUSCH RUs 1, 3, 5, 7, 9, and 11 may correspond to a second DMRS port. Each PUSCH RU can map to one or multiple preambles. In this example, PUSCH RUs 0 and 1 correspond to PRACH preambles {0, 6} and {3, 9}, respectively. The POs that are frequency division multiplexed in a given OFDM symbol set may correspond to a particular SSB. In the example of FIG. 3E, POs occupying symbols 0 to 2 correspond to SSB0, while those occupying symbols 2 to 5 correspond to SSB1, etc. There are 12 preambles associated with the PUSCH RUs corresponding to each SSB. The four different sets of POs in different OFDM symbol sets can be said to form a “msgA PUSCH slot” or “PUSCH group”.

Since there may be maximum 64 preambles that need to be mapped to msgA PUSCH RUs, restricting the number of POs per OFDM symbol to be a power of two can be considered to simplify the preamble to PUSCH RU mapping. However, allowing non-power of two PUSCH RUs per OFDM symbol can improve resource efficiency if fewer POs are needed. For example, if 3 POs per OFDM symbol is allowed instead of restricting to 4, 25% less PUSCH resource is needed.

In accordance with some exemplary embodiments, the number of PRACH preambles may be much larger than the number of POs since preambles use relatively little time-frequency resource compared to PUSCH. Therefore, there can be more PRACH preambles in a RO than there are PUSCH RUs that correspond to the RO. This can be seen in the exemplary RO to PO mapping shown in FIG. 3F.

In the example of FIG. 3F, preambles in a first RO are mapped to SSB0 and SSB1, while those in a second RO are mapped to SSB2 and SSB3. Since there are 6 PUSCH RUs per SSB and 2 PRACHs are mapped to each PUSCH RU (as shown in FIG. 3E), 12 preambles are needed for each SSB. Therefore, only 24 out of 64 preambles in a RO are needed to support the msgA PUSCH slot in this example. It can be observed that an integer number of preambles cannot be mapped to 12 PUSCH RUs such that there are 64 preambles. Therefore, a mechanism is needed to map a subset of preambles in a RO to PUSCH RUs. The mechanism may also allow PUSCH RUs to be mapped to different SSBs and can also support the case where multiple preambles are mapped to a PUSCH RU. Furthermore, since some preambles may be used for four-step contention based operation (e.g., Rel-15 contention based operation) and these preambles typically start at preamble index n·N_{preamble}^{total}/N, a way for two-step RA to use preambles not in use by the four-step contention based operation is needed.

In accordance with an exemplary embodiment, a UE can determine PRACH resource (e.g., PRACH preambles) associated with PUSCH RUs in a RA procedure such as a two-step RA procedure. For example, the UE can receive, from a gNB, signaling identifying a number N of SSBs associated with one RO and a number of preambles R′. According to an embodiment, R′ is equal to an integer multiple of a number of the PUSCH RUs that are frequency division multiplexed in an OFDM symbol set. For the case of N≥1, the UE can determine a start of consecutive PRACH resource associated to an SSB with index n, as a preamble index nₛₜₐᵣₜ′ for example, by the following formula:

$${n}_{start} = n \cdot {N}_{p r e amble}^{total} / N + {N}_{Δ} \qquad ( 1 )$$

where N_{preamble}^{total} is a number of preambles in a RO, which is an integer multiple of N, and N_{Δ} is an integer, where 0<N_{Δ}<N_{preamble}^{total}/N, which indicates an offset related to the start preamble. In some embodiments, N_{Δ} may be signaled to the UE in higher layer signaling from the gNB. The UE can determine the preambles associated with the PUSCH RUs as those with indices n_{RA} that satisfy:

$${n}_{s t a r t} \leq {n}_{R A} < {n}_{s t a r t} + {R}^{′} \qquad ( 2 )$$

Then the UE can transmit a preamble of the preambles associated with a PUSCH RU and transmit the PUSCH data in the PUSCH RU during the RA procedure.

In accordance with an exemplary embodiment where N<1, the UE can determine the start of consecutive PRACH resource (e.g., preambles) associated to an SSB with index n, as a preamble index nₛₜₐᵣₜ=N_{Δ}. In accordance with some exemplary embodiments, N_{Δ} is the number R of contention based preambles per SSB per valid RO identified by a higher layer parameter such as ssb-perRACH-OccasionAndCB-PreamblesPerSSB defined for four-step RA.

It will be realized that parameters, variables and settings related to the signaling transmission and resource allocation described herein are just examples. Other suitable message settings, the associated configuration parameters and the specific values thereof may also be applicable to implement the proposed methods.

It is noted that some embodiments of the present disclosure are mainly described in relation to 5G or NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

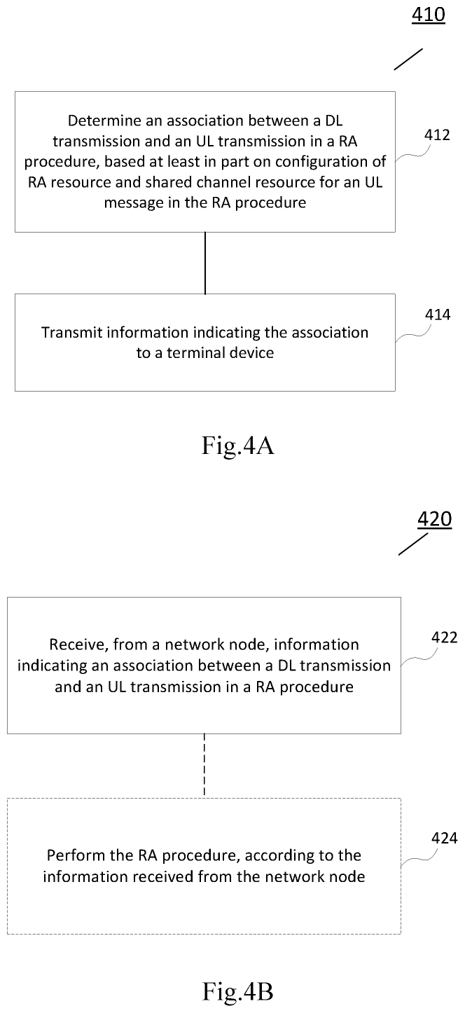

FIG. 4A is a flowchart illustrating a method 410 according to some embodiments of the present disclosure. The method 410 illustrated in FIG. 4A may be performed by a network node or an apparatus communicatively coupled to the network node. In accordance with an exemplary embodiment, the network node may comprise a base station such as gNB. The network node can be configured to communicate with one or more terminal devices such as UEs which may be able to support one or more RA approaches such as two-step RA and/or four-step RA.

According to the exemplary method 410 illustrated in FIG. 4A, the network node can determine an association between a DL transmission and an UL transmission (e.g., an association between an SSB and a shared channel occasion) in a RA procedure, based at least in part on configuration of RA resource (e.g., a RA occasion) and shared channel resource (e.g., the shared channel occasion) for an UL message (e.g. a message including a preamble and PUSCH data) in the RA procedure, as shown in block 412. In accordance with some exemplary embodiments, the UL message in the RA procedure may comprise message A including a preamble and PUSCH data (e.g., msgA payload). The RA procedure may be a two-step RA procedure. The network node can transmit information indicating the association to a terminal device, as shown in block 414. For example, the information indicating the association may be carried in a broadcast information block (such as SIB1) transmitted to the terminal device from the network node. Optionally, the terminal device may use the information indicating the association between the SSB and the shared channel occasion in the RA procedure to implement accessing to the network node.

FIG. 4B is a flowchart illustrating a method 420 according to some embodiments of the present disclosure. The method 420 illustrated in FIG. 4B may be performed by a terminal device or an apparatus communicatively coupled to the terminal device. In accordance with an exemplary embodiment, the terminal device such as a UE can be configured to communicate with a network node such as gNB by supporting one or more RA approaches such as two-step RA and/or four-step RA.

According to the exemplary method 420 illustrated in FIG. 4B, the terminal device may receive, from a network node (such as the network node described with respect to FIG. 4A), information indicating an association between a DL transmission and an UL transmission (e.g., an association between an SSB and a shared channel occasion) in a RA procedure, as shown in block 422. The association may be based at least in part on configuration of RA resource (e.g. a RA occasion) and shared channel resource (e.g. the shared channel occasion) for an UL message (e.g., message A or msgA described in connection with FIG. 2) in the RA procedure (e.g., a two-step RA procedure). Optionally, the terminal device may perform the RA procedure, according to the information received from the network node, as shown in block 424.

In accordance with some exemplary embodiments, the association between the DL transmission and the UL transmission may comprise an association between an SSB and a random access occasion (e.g., a PRACH occasion). Additionally or alternatively, the association between the DL transmission and the UL transmission may comprise an association between a SSB and a shared channel occasion (e.g., a PUSCH occasion).

In accordance with an exemplary embodiment, the UL transmission in the same shared channel occasion may be associated with one or more preambles mapped to one or more SSBs. For example, the UL shared channel data transmission in the same PO can be associated to the preambles mapped to same or different SSBs.

In accordance with some exemplary embodiments, the configuration of the RA occasion and the shared channel occasion may comprise one of:
one-to-one mapping of a preamble in the RA occasion to a RU in the shared channel occasion (e.g., the configuration as shown in FIG. 3A);
multiple-to-one mapping of preambles in the RA occasion to a RU in the shared channel occasion (e.g., the configuration as shown in FIG. 3C and FIG. 3D); and
one-to-multiple mapping of a preamble in the RA occasion to RUs in the shared channel occasion (e.g., the configuration as shown in FIG. 3B).

In accordance with some exemplary embodiments, the association between the SSB and the shared channel occasion may comprise: mapping of the SSB to a set of shared channel occasions comprising at least the shared channel occasion (e.g., the configuration as shown in FIGS. 3A-3C). In this case, the set of shared channel occasions may be configured with the same resource in time domain. In an embodiment, the SSB may be mapped to one or more preambles which are in the RA occasion and associated with one or more RUs in the set of shared channel occasions.

In accordance with some exemplary embodiments, the association between the SSB and the shared channel occasion may comprise: mapping of a set of SSBs comprising the SSB to the shared channel occasion. In this case, the SSB may be mapped to one or more preambles which are in the RA occasion and associated with one or more RUs in the shared channel occasion (e.g., the configuration as shown in FIG. 3D).

In accordance with some exemplary embodiments, the set of SSBs may be configured to enable optimized decoding of UL transmission of the terminal device. Optionally, the set of SSBs may be configured to have a beam difference higher than a predefined threshold.

In accordance with some exemplary embodiments, the shared channel occasion may be configured with a shared channel on which one or more reception beams of the network node associated with one or more SSBs are usable to receive data transmitted by the terminal device.

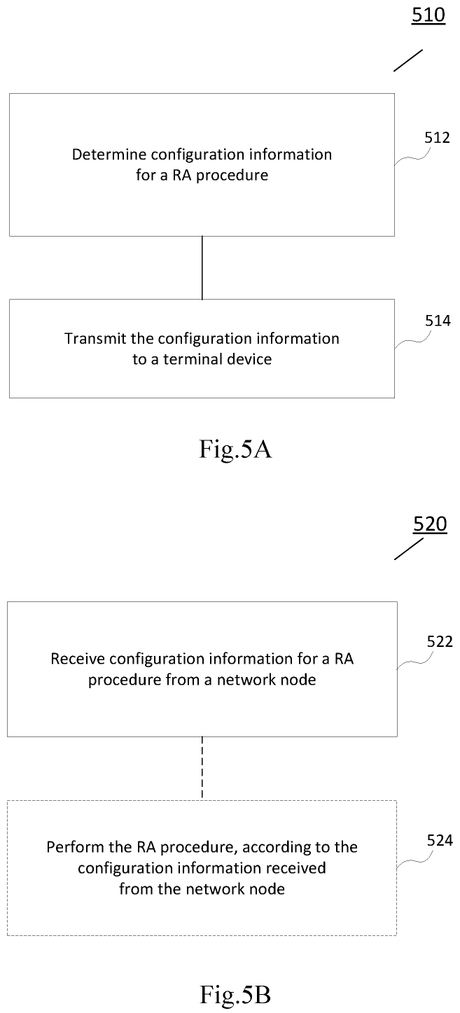

FIG. 5A is a flowchart illustrating a method 510 according to some embodiments of the present disclosure. The method 510 illustrated in FIG. 5A may be performed by a network node or an apparatus communicatively coupled to the network node. In accordance with an exemplary embodiment, the network node may comprise a base station such as gNB. The network node can be configured to communicate with one or more terminal devices such as UEs which may be able to support one or more RA approaches such as two-step RA and/or four-step RA.

According to the exemplary method 510 illustrated in FIG. 5A, the network node can determine configuration information for a RA procedure, as shown in block 512. In accordance with some exemplary embodiments, the configuration information may indicate a number of one or more SSBs associated with a RA occasion, and a number of one or more preambles which are in the RA occasion and associated with shared channel resource for the RA procedure. According to an exemplary embodiment, the RA procedure may be a two-step RA procedure. The network node can transmit the configuration information to a terminal device, as shown in block 514. Optionally, the terminal device may use the configuration information to implement accessing to the network node.

In accordance with some exemplary embodiments, the network node can transmit signaling information to the terminal device. The signaling information may indicate an offset which is usable for determining a start preamble associated with a specific SSB in the RA occasion.

Optionally, the network node may receive an UL message (e.g., message A or msgA described in connection with FIG. 2) for RA transmitted by the terminal device. The transmission of the UL message may use at least one preamble of the one or more preambles and the associated shared channel resource. The at least one preamble may be identified by at least one indicator which may be determined based at least in part on the configuration information.

FIG. 5B is a flowchart illustrating a method 520 according to some embodiments of the present disclosure. The method 520 illustrated in FIG. 5B may be performed by a terminal device or an apparatus communicatively coupled to the terminal device. In accordance with an exemplary embodiment, the terminal device such as a UE can be configured to communicate with a network node such as gNB by supporting one or more RA approaches such as two-step RA and/or four-step RA.

According to the exemplary method 520 illustrated in FIG. 5B, the terminal device may receive configuration information for a RA procedure from a network node (such as the network node described with respect to FIG. A), as shown in block 522. The configuration information may indicate a number of one or more SSBs associated with a RA occasion, and a number of one or more preambles which are in the RA occasion and associated with shared channel resource for the RA procedure (e.g., a two-step RA procedure). Optionally, the terminal device may perform the RA procedure, according to the configuration information received from the network node, as shown in block 524.

In accordance with some exemplary embodiments, the shared channel resource may comprise shared channel resource units which are frequency division multiplexed in one or more symbols (e.g., OFDM symbols).

In accordance with some exemplary embodiments, the number of the one or more preambles may be equal to an integer multiple of a number of the shared channel resource units.

In accordance with some exemplary embodiments, the terminal device can receive signaling information from the network node. The signaling information may indicate an offset which is usable for determining a start preamble associated with a specific SSB in the RA occasion.

In accordance with some exemplary embodiments, the offset may be equal to a number of one or more preambles which are configured for another RA procedure (e.g., a four-step RA procedure) and associated with the specific SSB.

In accordance with some exemplary embodiments, the terminal device may perform the RA procedure by determining at least one indicator for the one or more preambles, based at least in part on the configuration information, for example, according to formula (1) and formula (2).

In accordance with some exemplary embodiments, the terminal device may perform the RA procedure further by transmitting an UL message (e.g., message A or msgA described in connection with FIG. 2) for RA to the network node, through using at least one preamble of the one or more preambles and the associated shared channel resource. The at least one preamble may be identified by the determined at least one indicator (such as a preamble index n_{RA}).

The proposed solution according to one or more exemplary embodiments can enable an association between a DL transmission and an UL transmission (e.g. an association between an SSB and a shared channel occasion) based at least in part on a specified configuration rule for a RA procedure such as a two-step RA procedure. In some exemplary embodiments, according to the mapping configuration of PRACH resource (e.g., one or more preambles per RO) and PUSCH resource (e.g., one or more RUs per PO) for msgA transmission in the two-step RA procedure, the association between the DL transmission and the UL transmission (e.g., the SSB to RO and msgA preamble as well as PO mapping) can be determined for the two-step RA procedure. Various configuration rules and parameters may be used for the SSB to PO mapping to support application of beamforming in the two-step RA procedure, so as to improve flexibility of transmission configuration and performance of signaling processing, and enhance resource utilization.

The various blocks shown in FIGS. 4A-5B may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

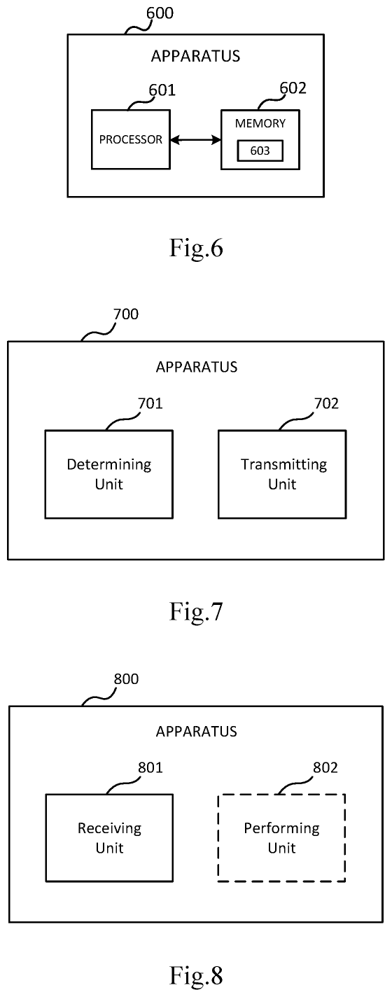

FIG. 6 is a block diagram illustrating an apparatus 600 according to various embodiments of the present disclosure. As shown in FIG. 6, the apparatus 600 may comprise one or more processors such as processor 601 and one or more memories such as memory 602 storing computer program codes 603. The memory 602 may be non-transitory machine/processor/computer readable storage medium. In accordance with some exemplary embodiments, the apparatus 600 may be implemented as an integrated circuit chip or module that can be plugged or installed into a network node as described with respect to FIG. 4A or FIG. 5A, or a terminal device as described with respect to FIG. 4B or FIG. 5B. In such case, the apparatus 600 may be implemented as a network node as described with respect to FIG. 4A or FIG. 5A, or a terminal device as described with respect to FIG. 4B or FIG. 5B.

In some implementations, the one or more memories 602 and the computer program codes 603 may be configured to, with the one or more processors 601, cause the apparatus 600 at least to perform any operation of the method as described in connection with FIG. 4A. In other implementations, the one or more memories 602 and the computer program codes 603 may be configured to, with the one or more processors 601, cause the apparatus 600 at least to perform any operation of the method as described in connection with FIG. 4B. In other implementations, the one or more memories 602 and the computer program codes 603 may be configured to, with the one or more processors 601, cause the apparatus 600 at least to perform any operation of the method as described in connection with FIG. 5A. In other implementations, the one or more memories 602 and the computer program codes 603 may be configured to, with the one or more processors 601, cause the apparatus 600 at least to perform any operation of the method as described in connection with FIG. 5B. Alternatively or additionally, the one or more memories 602 and the computer program codes 603 may be configured to, with the one or more processors 601, cause the apparatus 600 at least to perform more or less operations to implement the proposed methods according to the exemplary embodiments of the present disclosure.

FIG. 7 is a block diagram illustrating an apparatus 700 according to some embodiments of the present disclosure. As shown in FIG. 7, the apparatus 700 may comprise a determining unit 701 and a transmitting unit 702. In an exemplary embodiment, the apparatus 700 may be implemented in a network node such as a gNB. The determining unit 701 may be operable to carry out the operation in block 412, and the transmitting unit 702 may be operable to carry out the operation in block 414. Alternatively or additionally, the determining unit 701 may be operable to carry out the operation in block 512, and the transmitting unit 702 may be operable to carry out the operation in block 514. Optionally, the determining unit 701 and/or the transmitting unit 702 may be operable to carry out more or less operations to implement the proposed methods according to the exemplary embodiments of the present disclosure.

FIG. 8 is a block diagram illustrating an apparatus 800 according to some embodiments of the present disclosure. As shown in FIG. 8, the apparatus 800 may comprise a receiving unit 801, and optionally a performing unit 802. In an exemplary embodiment, the apparatus 800 may be implemented in a terminal device such as a UE. The receiving unit 801 may be operable to carry out the operation in block 422, and the performing unit 802 may be operable to carry out the operation in block 424. Alternatively or additionally, the receiving unit 801 may be operable to carry out the operation in block 522, and the performing unit 802 may be operable to carry out the operation in block 524. Optionally, the receiving unit 801 and/or the performing unit 802 may be operable to carry out more or less operations to implement the proposed methods according to the exemplary embodiments of the present disclosure.

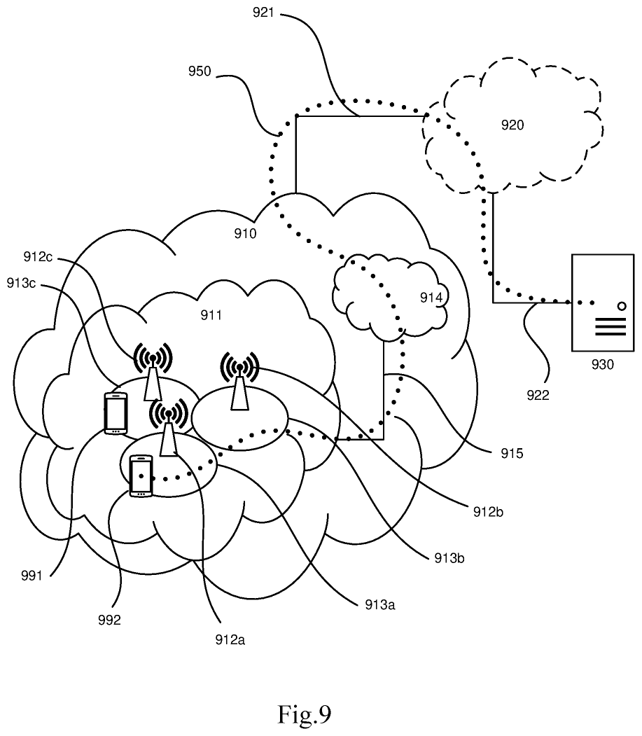

FIG. 9 is a block diagram illustrating a telecommunication network connected via an intermediate network to a host computer in accordance with some embodiments of the present disclosure.

With reference to FIG. 9, in accordance with an embodiment, a communication system includes a telecommunication network 910, such as a 3GPP-type cellular network, which comprises an access network 911, such as a radio access network, and a core network 914. The access network 911 comprises a plurality of base stations 912a, 912b, 912c, such as NBs, eNBs, gNBs or other types of wireless access points, each defining a corresponding coverage area 913a, 913b, 913c. Each base station 912a, 912b, 912c is connectable to the core network 914 over a wired or wireless connection 915. A first UE 991 located in a coverage area 913c is configured to wirelessly connect to, or be paged by, the corresponding base station 912c. A second UE 992 in a coverage area 913a is wirelessly connectable to the corresponding base station 912a. While a plurality of UEs 991, 992 are illustrated in this example, the disclosed embodiments are equally applicable to a situation where a sole UE is in the coverage area or where a sole UE is connecting to the corresponding base station 912.

The telecommunication network 910 is itself connected to a host computer 930, which may be embodied in the hardware and/or software of a standalone server, a cloud-implemented server, a distributed server or as processing resources in a server farm. The host computer 930 may be under the ownership or control of a service provider, or may be operated by the service provider or on behalf of the service provider. Connections 921 and 922 between the telecommunication network 910 and the host computer 930 may extend directly from the core network 914 to the host computer 930 or may go via an optional intermediate network 920. An intermediate network 920 may be one of, or a combination of more than one of, a public, private or hosted network; the intermediate network 920, if any, may be a backbone network or the Internet; in particular, the intermediate network 920 may comprise two or more sub-networks (not shown).

The communication system of FIG. 9 as a whole enables connectivity between the connected UEs 991, 992 and the host computer 930. The connectivity may be described as an over-the-top (OTT) connection 950. The host computer 930 and the connected UEs 991, 992 are configured to communicate data and/or signaling via the OTT connection 950, using the access network 911, the core network 914, any intermediate network 920 and possible further infrastructure (not shown) as intermediaries. The OTT connection 950 may be transparent in the sense that the participating communication devices through which the OTT connection 950 passes are unaware of routing of uplink and downlink communications. For example, the base station 912 may not or need not be informed about the past routing of an incoming downlink communication with data originating from the host computer 930 to be forwarded (e.g., handed over) to a connected UE 991. Similarly, the base station 912 need not be aware of the future routing of an outgoing uplink communication originating from the UE 991 towards the host computer 930.

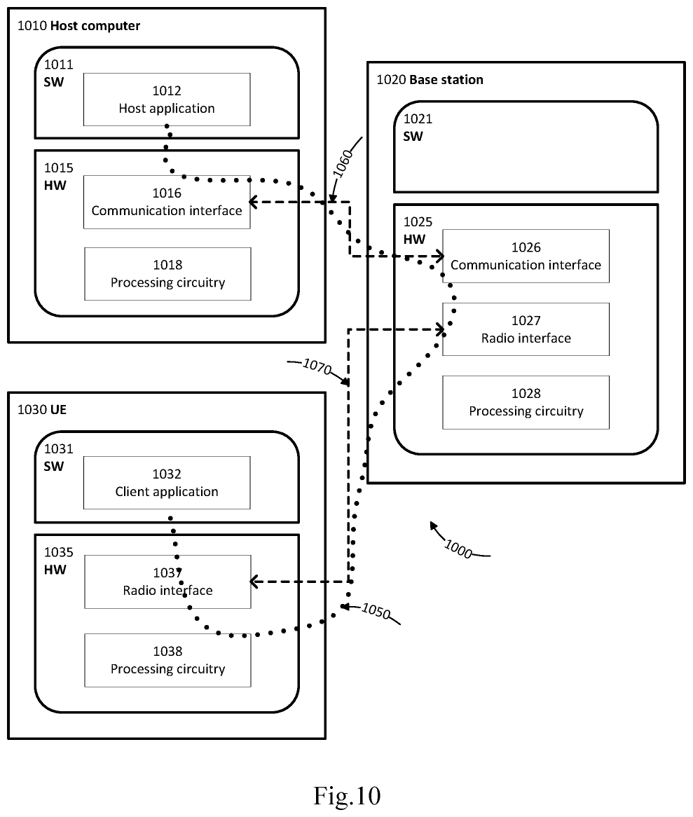

FIG. 10 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 10. In a communication system 1000, a host computer 1010 comprises hardware 1015 including a communication interface 1016 configured to set up and maintain a wired or wireless connection with an interface of a different communication device of the communication system 1000. The host computer 1010 further comprises a processing circuitry 1018, which may have storage and/or processing capabilities. In particular, the processing circuitry 1018 may comprise one or more programmable processors, application-specific integrated circuits, field programmable gate arrays or combinations of these (not shown) adapted to execute instructions. The host computer 1010 further comprises software 1011, which is stored in or accessible by the host computer 1010 and executable by the processing circuitry 1018. The software 1011 includes a host application 1012. The host application 1012 may be operable to provide a service to a remote user, such as UE 1030 connecting via an OTT connection 1050 terminating at the UE 1030 and the host computer 1010. In providing the service to the remote user, the host application 1012 may provide user data which is transmitted using the OTT connection 1050.

The communication system 1000 further includes a base station 1020 provided in a telecommunication system and comprising hardware 1025 enabling it to communicate with the host computer 1010 and with the UE 1030. The hardware 1025 may include a communication interface 1026 for setting up and maintaining a wired or wireless connection with an interface of a different communication device of the communication system 1000, as well as a radio interface 1027 for setting up and maintaining at least a wireless connection 1070 with the UE 1030 located in a coverage area (not shown in FIG. 10) served by the base station 1020. The communication interface 1026 may be configured to facilitate a connection 1060 to the host computer 1010. The connection 1060 may be direct or it may pass through a core network (not shown in FIG. 10) of the telecommunication system and/or through one or more intermediate networks outside the telecommunication system. In the embodiment shown, the hardware 1025 of the base station 1020 further includes a processing circuitry 1028, which may comprise one or more programmable processors, application-specific integrated circuits, field programmable gate arrays or combinations of these (not shown) adapted to execute instructions. The base station 1020 further has software 1021 stored internally or accessible via an external connection.

The communication system 1000 further includes the UE 1030 already referred to. Its hardware 1035 may include a radio interface 1037 configured to set up and maintain a wireless connection 1070 with a base station serving a coverage area in which the UE 1030 is currently located. The hardware 1035 of the UE 1030 further includes a processing circuitry 1038, which may comprise one or more programmable processors, application-specific integrated circuits, field programmable gate arrays or combinations of these (not shown) adapted to execute instructions. The UE 1030 further comprises software 1031, which is stored in or accessible by the UE 1030 and executable by the processing circuitry 1038. The software 1031 includes a client application 1032. The client application 1032 may be operable to provide a service to a human or non-human user via the UE 1030, with the support of the host computer 1010. In the host computer 1010, an executing host application 1012 may communicate with the executing client application 1032 via the OTT connection 1050 terminating at the UE 1030 and the host computer 1010. In providing the service to the user, the client application 1032 may receive request data from the host application 1012 and provide user data in response to the request data. The OTT connection 1050 may transfer both the request data and the user data. The client application 1032 may interact with the user to generate the user data that it provides.

It is noted that the host computer 1010, the base station 1020 and the UE 1030 illustrated in FIG. 10 may be similar or identical to the host computer 930, one of base stations 912a, 912b, 912c and one of UEs 991, 992 of FIG. 9, respectively. This is to say, the inner workings of these entities may be as shown in FIG. 10 and independently, the surrounding network topology may be that of FIG. 9.

In FIG. 10, the OTT connection 1050 has been drawn abstractly to illustrate the communication between the host computer 1010 and the UE 1030 via the base station 1020, without explicit reference to any intermediary devices and the precise routing of messages via these devices. Network infrastructure may determine the routing, which it may be configured to hide from the UE 1030 or from the service provider operating the host computer 1010, or both. While the OTT connection 1050 is active, the network infrastructure may further take decisions by which it dynamically changes the routing (e.g., on the basis of load balancing consideration or reconfiguration of the network).

Wireless connection 1070 between the UE 1030 and the base station 1020 is in accordance with the teachings of the embodiments described throughout this disclosure. One or more of the various embodiments improve the performance of OTT services provided to the UE 1030 using the OTT connection 1050, in which the wireless connection 1070 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 1050 between the host computer 1010 and the UE 1030, in response to variations in the measurement results. The measurement procedure and/or the network functionality for reconfiguring the OTT connection 1050 may be implemented in software 1011 and hardware 1015 of the host computer 1010 or in software 1031 and hardware 1035 of the UE 1030, or both. In embodiments, sensors (not shown) may be deployed in or in association with communication devices through which the OTT connection 1050 passes; the sensors may participate in the measurement procedure by supplying values of the monitored quantities exemplified above, or supplying values of other physical quantities from which the software 1011, 1031 may compute or estimate the monitored quantities. The reconfiguring of the OTT connection 1050 may include message format, retransmission settings, preferred routing etc.; the reconfiguring need not affect the base station 1020, and it may be unknown or imperceptible to the base station 1020. Such procedures and functionalities may be known and practiced in the art. In certain embodiments, measurements may involve proprietary UE signaling facilitating the host computer 1010's measurements of throughput, propagation times, latency and the like. The measurements may be implemented in that the software 1011 and 1031 causes messages to be transmitted, in particular empty or ‘dummy’ messages, using the OTT connection 1050 while it monitors propagation times, errors etc.

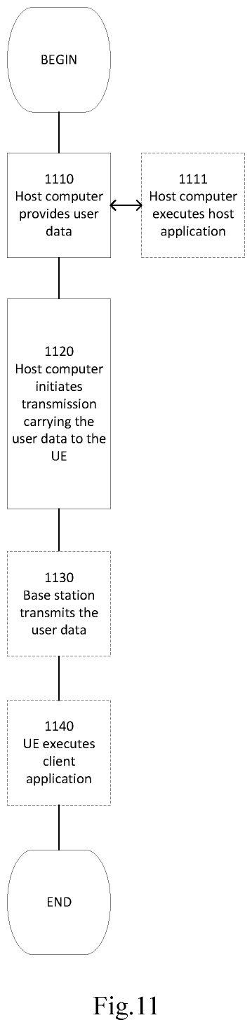

FIG. 11 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 11 will be included in this section. In step 1110, the host computer provides user data. In substep 1111 (which may be optional) of step 1110, the host computer provides the user data by executing a host application. In step 1120, the host computer initiates a transmission carrying the user data to the UE. In step 1130 (which may be optional), the base station transmits to the UE the user data which was carried in the transmission that the host computer initiated, in accordance with the teachings of the embodiments described throughout this disclosure. In step 1140 (which may also be optional), the UE executes a client application associated with the host application executed by the host computer.

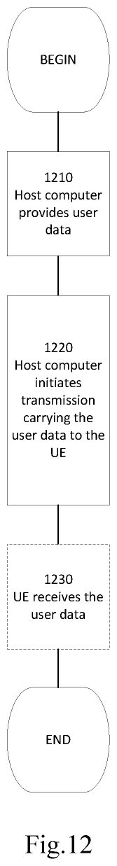

FIG. 12 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 12 will be included in this section. In step 1210 of the method, the host computer provides user data. In an optional substep (not shown) the host computer provides the user data by executing a host application. In step 1220, the host computer initiates a transmission carrying the user data to the UE. The transmission may pass via the base station, in accordance with the teachings of the embodiments described throughout this disclosure. In step 1230 (which may be optional), the UE receives the user data carried in the transmission.

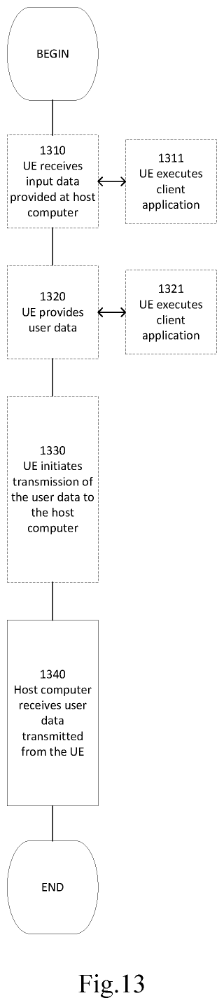

FIG. 13 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 13 will be included in this section. In step 1310 (which may be optional), the UE receives input data provided by the host computer. Additionally or alternatively, in step 1320, the UE provides user data. In substep 1321 (which may be optional) of step 1320, the UE provides the user data by executing a client application. In substep 1311 (which may be optional) of step 1310, the UE executes a client application which provides the user data in reaction to the received input data provided by the host computer. In providing the user data, the executed client application may further consider user input received from the user. Regardless of the specific manner in which the user data was provided, the UE initiates, in substep 1330 (which may be optional), transmission of the user data to the host computer. In step 1340 of the method, the host computer receives the user data transmitted from the UE, in accordance with the teachings of the embodiments described throughout this disclosure.

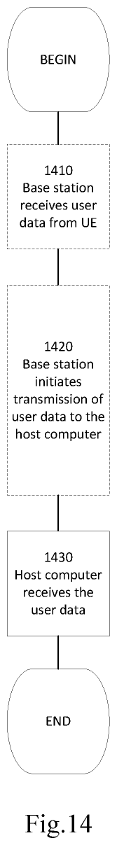

FIG. 14 is a flowchart illustrating a method implemented in a communication system, in accordance with an embodiment. The communication system includes a host computer, a base station and a UE which may be those described with reference to FIG. 9 and FIG. 10. For simplicity of the present disclosure, only drawing references to FIG. 14 will be included in this section. In step 1410 (which may be optional), in accordance with the teachings of the embodiments described throughout this disclosure, the base station receives user data from the UE. In step 1420 (which may be optional), the base station initiates transmission of the received user data to the host computer. In step 1430 (which may be optional), the host computer receives the user data carried in the transmission initiated by the base station.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method performed by a terminal device, comprising:
receiving, from a network node, information indicating an association between a synchronization signal and physical broadcast channel block and a shared channel occasion in a random access procedure, wherein the association is based at least in part on configuration of a random access occasion and the shared channel occasion for an uplink message including a preamble and physical uplink shared channel data in the random access procedure.

2. The method according to claim 1, wherein the configuration of the random access occasion and the shared channel occasion comprises one of:
one-to-one mapping of a preamble in the random access occasion to a resource unit in the shared channel occasion; and
multiple-to-one mapping of preambles in the random access occasion to a resource unit in the shared channel occasion.

3. The method according to claim 1, wherein the association between the synchronization signal and physical broadcast channel block and the shared channel occasion comprises:
mapping of the synchronization signal and physical broadcast channel block to a set of shared channel occasions comprising at least the shared channel occasion, wherein the set of shared channel occasions is configured with the same resource in time domain.

4. The method according to claim 3, wherein the synchronization signal and physical broadcast channel block is mapped to one or more preambles which are in the random access occasion and associated with one or more resource units in the set of shared channel occasions.

5. The method according to claim 1, wherein the association between the synchronization signal and physical broadcast channel block and the shared channel occasion comprises:
mapping of a set of synchronization signal and physical broadcast channel blocks comprising the synchronization signal and physical broadcast channel block to the shared channel occasion.

6. The method according to claim 5, wherein the synchronization signal and physical broadcast channel block is mapped to one or more preambles which are in the random access occasion and associated with one or more resource units in the shared channel occasion.

7. The method according to claim 5, wherein the set of synchronization signal and physical broadcast channel blocks are configured to enable optimized decoding of uplink transmission of the terminal device.

8. The method according to claim 5, wherein the set of synchronization signal and physical broadcast channel blocks are configured to have a beam difference higher than a predefined threshold.

9. The method according to claim 1, wherein the shared channel occasion is configured with a shared channel on which one or more reception beams of the network node associated with one or more synchronization signal and physical broadcast channel blocks are usable to receive data transmitted by the terminal device.

10. The method according to claim 1, wherein uplink transmission in the shared channel occasion is associated with one or more preambles mapped to one or more synchronization signal and physical broadcast channel blocks.

11. A method performed by a network node, comprising:
determining an association between a synchronization signal and physical broadcast channel block and a shared channel occasion in a random access procedure, based at least in part on configuration of a random access occasion and the shared channel occasion for an uplink message including a preamble and physical uplink shared channel data in the random access procedure; and
transmitting information indicating the association to a terminal device.

12. The method according to claim 11, wherein the configuration of the random access occasion and the shared channel occasion comprises one of:
one-to-one mapping of a preamble in the random access occasion to a resource unit in the shared channel occasion; and
multiple-to-one mapping of preambles in the random access occasion to a resource unit in the shared channel occasion.

13. The method according to claim 11, wherein the association between the synchronization signal and physical broadcast channel block and the shared channel occasion comprises:
mapping of the synchronization signal and physical broadcast channel block to a set of shared channel occasions comprising at least the shared channel occasion, wherein the set of shared channel occasions is configured with the same resource in time domain.

14. The method according to claim 13, wherein the synchronization signal and physical broadcast channel block is mapped to one or more preambles which are in the random access occasion and associated with one or more resource units in the set of shared channel occasions.

15. The method according to claim 11, wherein the association between the synchronization signal and physical broadcast channel block and the shared channel occasion comprises:
mapping of a set of synchronization signal and physical broadcast channel blocks comprising the synchronization signal and physical broadcast channel block to the shared channel occasion.

16. The method according to claim 15, wherein the synchronization signal and physical broadcast channel block is mapped to one or more preambles which are in the random access occasion and associated with one or more resource units in the shared channel occasion.

17. The method according to claim 15, wherein the set of synchronization signal and physical broadcast channel blocks are configured to enable optimized decoding of uplink transmission of the terminal device.

18. (canceled)

19. The method according to claim 11, wherein the shared channel occasion is configured with a shared channel on which one or more reception beams of the network node associated with one or more synchronization signal and physical broadcast channel blocks are usable to receive data transmitted by the terminal device.

20. The method according to claim 11, wherein uplink transmission in the shared channel occasion is associated with one or more preambles mapped to one or more synchronization signal and physical broadcast channel blocks.

21. A terminal device, comprising:
one or more processors; and
one or more memories comprising computer program codes which, when executed by the one or more processors, cause the terminal device at least to:
receive, from a network node, information indicating an association between a synchronization signal and physical broadcast channel block and a shared channel occasion in a random access procedure, wherein the association is based at least in part on configuration of a random access occasion and the shared channel occasion for an uplink message including a preamble and physical uplink shared channel data in the random access procedure.

22-42. (canceled)
